(19) United States
(12) Patent Application Publication
(10) Pub. No.: US 2025/0113940 A1
(43) Pub. Date: Apr. 10, 2025

(54) QUICK ATTACH AND RELEASE SPRAY HEAD ASSEMBLY, ADAPTER, AND METHOD OF USE

(71) Applicant: BUNN-O-MATIC CORPORATION, Springfield, IL (US)

(72) Inventors: Charles H. CLARK, Springfield, IL (US); Jason M. BANNING, Springfield, IL (US); Jane BOEHLER, Springfield, IL (US)

(21) Appl. No.: 18/983,975

(22) Filed: Dec. 17, 2024

Related U.S. Application Data
(63) Continuation-in-part of application No. 17/127,192, filed on Dec. 18, 2020, now Pat. No. 12,168,241.
(60) Provisional application No. 62/970,559, filed on Feb. 5, 2020.
(60) Provisional application No. 63/002,171, filed on Mar. 30, 2020.

(51) Int. Cl. A47J 31/44; A47J 31/46

(52) U.S. Cl. CPC A47J 31/4478; A47J 31/461

(57) ABSTRACT

A spray head assembly for use with a beverage brewer includes a spray head and an adapter. The spray head includes a front portion including a plurality of holes for dispensing water therethrough and a backer plate having a turn mechanism. The adapter includes a body having an outer portion and a threaded inner portion. The body has an opening through the threaded inner portion that is attachable to an outlet tube of the beverage brewer. The outer portion of the body includes tabs that are engageable with the turn mechanism of the backer plate by inserting the tabs into the turn mechanism and rotating the backer plate to engage the tabs.

### CROSS-REFERENCE TO RELATED APPLICATIONS

This is a Continuation-in-Part application of U.S. patent application Ser. No. 17/127, 192, filed Dec. 18, 2020, issued as U.S. Pat. No. 12,168,241 on Dec. 17, 2024, which claims priority to U.S. Provisional Patent Application Ser. No. 62/970,559, filed Feb. 5, 2020, and to U.S. Provisional Patent Application Ser. No. 63/002,171, filed Mar. 30, 2020. The disclosures set forth in the applications referenced above are incorporated herein by reference in their entities.

### BACKGROUND

The present disclosure generally relates to a beverage brewing apparatus, and more specifically, to an adapter for attaching spray head assembly to a spray head valve of the beverage brewing apparatus.

Generally, spray heads are used in beverage making equipment to dispense and distribute water to a beverage making substance. These spray heads are attached to a water delivery line generally in an upper housing portion of the beverage maker. Such spray heads are generally enclosed structures with a mounting portion for attachment to and removal from the water delivery line. A portion of the spray head includes one or more holes through which water is dispensed. A variety of attachment devices can be used to attach a spray head to a brewer including, as examples, a threaded attachment, clipped attachment or magnetic attachment. These spray heads tend to be formed of two or more plastic pieces which are sealed to form a chamber for accumulating and distributing water through holes formed in the spray head. Plastic spray heads can be advantageous to obtain flow characteristics and resistance to buildup of undesired particles such as lime. Further, plastic spray heads are more easily moldable and less costly compared to spray heads formed of other materials.

However, an issue with using spray heads formed of primarily plastic material is damage that can occur on threaded portions of the spray head used to attach the spray head to an spray head valve of the beverage making equipment, such as a backer plate. More particularly, male threads on the valve are typically formed of a metal material. When engaged with the female threads of the backer plate, cross-threading can occur. If further engaged, then damage to the plastic thread can potentially occur in turn. This issue can worsen over time as a user routinely detaches, cleans, and reattaches the plastic spray head.

### BRIEF DESCRIPTION OF THE DRAWINGS

FIG. 1 is a perspective view of a hood of a beverage brewer having a removable spray head assembly;

FIG. 2 is an exploded view of a spray head assembly;

FIG. 3 is another exploded view of the four pieces of a spray head assembly shown relative to a valve of a beverage brewer;

FIGS. 4-6 are various views of an embodiment of a spray head adapter of a spray head assembly;

FIGS. 7 and 8 are conceptual diagrams of a fitting used as a spray head adapter to attach to a threaded portion of a valve;

FIGS. 9 and 10 are conceptual diagrams of a fitting of a backer plate of a spray head assembly for attachment to a valve via a spray head adapter;

FIGS. 11-13 are various views of another embodiment of a spray head adapter of a spray head assembly;

FIGS. 14-16 are conceptual diagrams of a fitting of a valve used to attach a spray head assembly via a spray head adapter;

FIG. 17 are cross-sectional views of an embodiment of the spray head adapter positioned for engagement with the backer plate;

FIG. 18 is a perspective view of another embodiment of the spray head assembly;

FIG. 19 is an exploded view of the three pieces of the spray head assembly of FIG. 18;

FIG. 20 is a perspective view of a front portion of a spray head of the spray head assembly of FIG. 18;

FIG. 21 is a perspective view of a spray head adapter of the spray head assembly of FIG. 18;

FIGS. 22A and 22B are top and bottom perspective views, respectively, of a backer plate of the spray head assembly of FIG. 18;

FIG. 23 is a conceptual diagram of positioning the adapter for engagement with the backer plate of the spray head assembly of FIG. 18; and

FIGS. 24A-C are conceptual diagrams providing progressive views of a cross-sectional view of fitting the backer plate of the spray head assembly of FIG. 18 onto the adapter of the spray head assembly.

### DETAILED DESCRIPTION

While the present disclosure may be susceptible to embodiments in different forms, there is shown in the drawings, and described herein in detail, embodiments with the understanding that the present description exemplifies principles of the disclosure and does not intend to exhaust or limit the disclosure to the details of construction and the arrangements of components set forth in the following description and illustrated in the drawings. The present disclosure is described in connection with one or more contemplated embodiments which are not intended to be limiting of the scope of the present disclosure. The present disclosure is intended to encompass those embodiments as well as equivalents and variations.

Terms including beverage, brewed, brewing, and brewed beverage, as may be used herein, are intended to be broadly defined as including, but not limited to the brewing or making of tea, coffee, and any other beverages or food substances that will benefit from the present disclosure. This broad interpretation is also intended to include, but be limited to, any process of dispensing, infusing, steeping, reconstituting, diluting, dissolving, saturating, or passing a liquid through or otherwise mixing or combining a beverage substance with a liquid such as water without limitation to the temperature of such liquid unless specified. This broad interpretation is also intended to include, but is not limited to beverage substances such as ground coffee, tea, liquid beverage concentrate, powdered beverage concentrate, flaked, granular, freeze-dried or other forms of materials including liquid, gel, crystal, or other form of beverage or food materials to obtain a desired beverage or food product. This broad interpretation is further intended to include, without limitation, at least funnel and filter-type, packet or pouch-type, pod-type, or other pre-packaged or unpackaged forms of retaining and brewing a beverage or making of a food product. The terms heated water may be interpreted as hot water, and generally refers to adding energy to water to heat the water above ambient temperature.

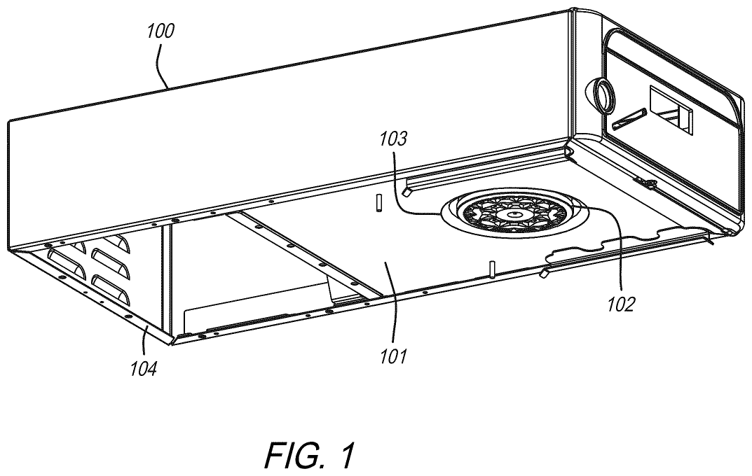

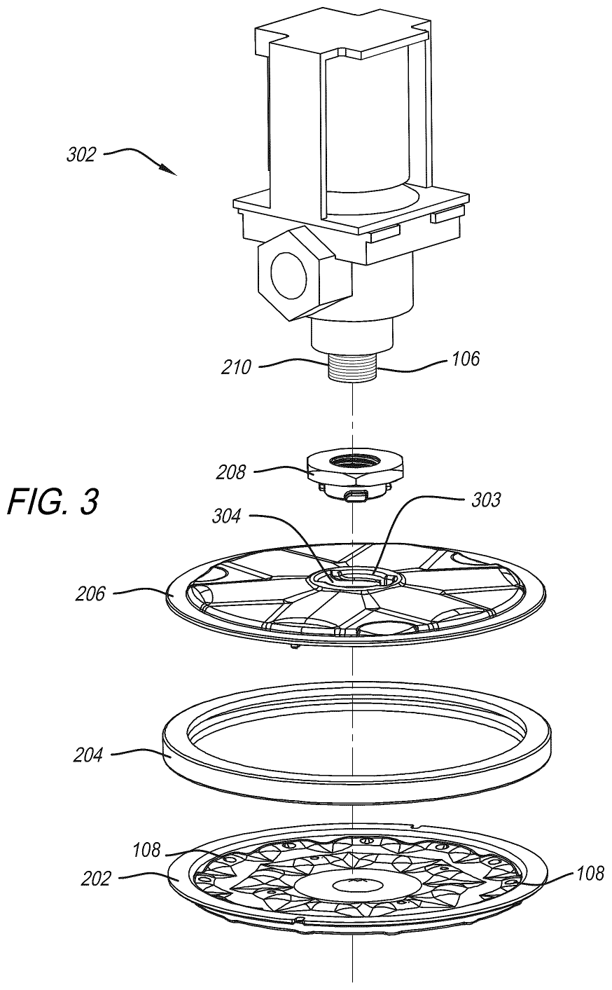

Referring now to FIG. 1, a hood 100 of a beverage brewer is shown. The beverage brewer is used to make a heated beverage, such as coffee, tea, or soup. The hood 100 may be attached to a body (not shown) of the beverage brewer at a base 101. Such a brewer is of known construction and typically includes a hot water reservoir which controllably dispenses hot water through a water supply dispensing tube connected to a spray head and distributed onto a beverage making substance retained in a substance holder or funnel. When used to make a heated beverage, a heater of a liquid reservoir of the brewer may controllably heat the liquid (water) to a desired temperature. For making coffee and tea, the water in the liquid reservoir may be heated at a temperature approaching boiling, e.g., about 190-205 degrees Fahrenheit. Such a heating element may be coupled with and controlled by a controller. Further, an inlet tube may be coupled to and communicate with the liquid reservoir for dispensing liquid into the liquid reservoir. The controller is operable to permit liquid to flow out of the reservoir via a brew water dispensing line or an outlet tube 106. A controllable outlet valve is associated with the outlet tube and controllably operated by the controller. When the outlet valve is open, liquid can pass out of the outlet tube 106 and into the cavity of a spray head 102 (also referred to herein as a “spray head assembly”) located within a sump area 103 of the base 101 to be distributed through several openings or holes 108 (see, FIG. 3) in the spray head 102 over beverage making material retained in a brew funnel which is positioned below the spray head in a known manner to allow the liquid to contact the beverage making material to make a desired beverage. The brewed beverage is then passed from the funnel to into a container such as a coffee carafe for distribution and consumption positioned below the funnel.

Over time with use, the spray head assembly 102 may require cleaning. That can be due to residual liquid draining into portions of the spray head and evaporating, leaving residue, such as lime, particles, and other minerals. In cleaning the spray head 102, a user may detach the spray head 102 from the brewer, clean the spray head 102, and reattach the spray head 102. In some embodiments, the spray head 102 may be formed of thermoplastic, which tends to reduce the amount of mineral accumulation and make the need for cleaning to be relatively less frequent compared to spray heads formed of other materials. Further, the use of thermoplastic also allows for easier disassembly and reassembly of the spray head. One concern with detaching and reattaching a plastic spray head with a brewer involves damage to plastic threads of the spray head by threading the spray head onto a metal thread of the valve during reattachment. In doing so, cross-threading may occur and damage the plastic threads if further engaged.

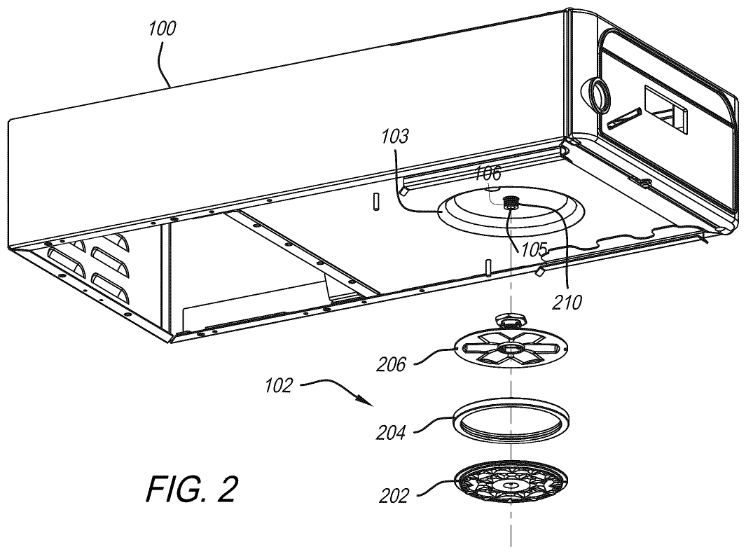

Embodiments presented herein disclose a quick release adapter included with the spray head assembly 102 that can be threaded on the outlet tube 106 through an opening on the adapter. The spray head 102 is removably attachable to the adapter via one or more cars or tabs on the adapter that engage with the spray head 102, eliminating the need for threading the spray head 102 to the valve every time it is attached, removed, and reattached. FIG. 2 depicts an exploded view of the hood 100, exposing the components of the spray head assembly 102. Illustratively, the spray head assembly 102 includes a bottom portion (also referred to as a “front portion”) 202, a retainer 204, and a top portion (also referred to herein as a “backer plate”) 206. In use, the bottom portion 202 and the top portion 206 are engaged using the retainer 204, which provides a retaining means for the top portion 206 and the bottom portion 202. Further, the spray head assembly includes an adapter 208. In an embodiment, the adapter 208 may be formed of a metallic material, such as brass or nickel. Further, the outlet tube 106 includes a threaded portion 210 having threads on the surface of the outlet tube for receiving the adapter 208.

While the present embodiments show the adapter 208 attached to a threaded outlet on a valve, there are embodiments of brewers, which have an outlet tube 106 not directly associated with a valve. In other words, brewers of known construction may have an outlet line for dispensing heated water to the spray head that are not directly extending from a valve. In other words, the valve could be further upstream from the spray head. Furthermore, a brewer configuration might be provided in which an outlet line extends from a heated water reservoir within the brewer directly to the spray head without an intervening valve. Regardless of the specific configuration of the valve and outlet line, a threaded connection is typically provided to which the spray head assembly is attached.

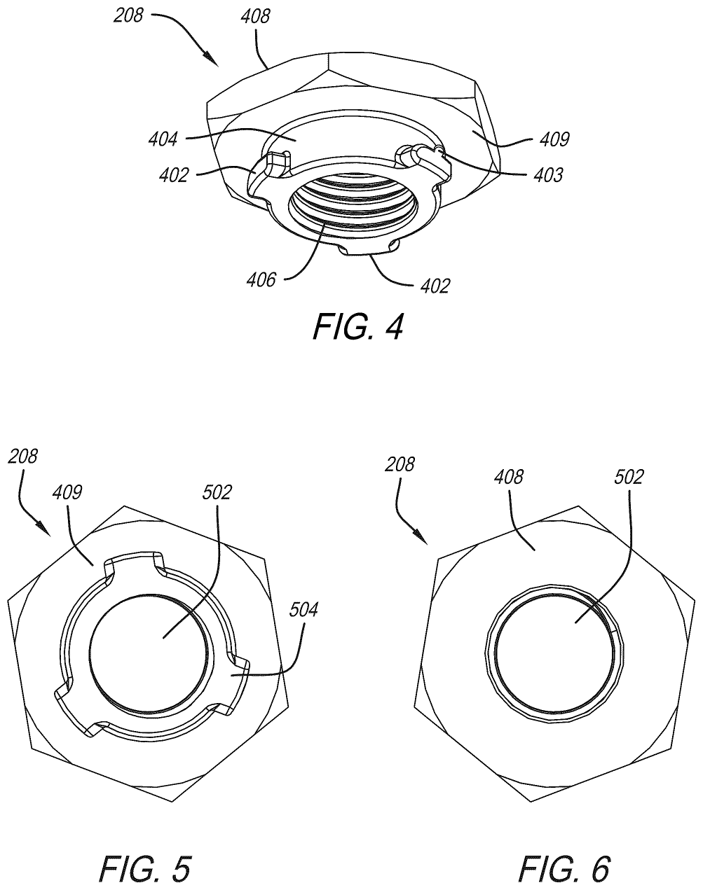

Referring to FIGS. 4-6, several views of the adapter 208 are shown. FIG. 4 depicts a perspective view of the adapter 208. FIG. 5 depicts a view of the bottom of the adapter 208. FIG. 6 depicts an overhead view of the adapter 502. As shown, the adapter 208 includes a body 404, a top portion 408, a top surface portion 409, and a bottom portion 504. The top portion 408 may be embodied as a hex piece used for sealing the backer plate 206 at the top surface portion 409. Generally, to seal the backer plate 206 with the top surface portion 409, the hex piece should be large enough to cover the opening in the backer plate 206. The body 404 is generally cylindrical in shape having an outer portion and an inner threaded portion 406. The body 404 also includes cars 402. In addition, body 404 can optionally include an car 403 protruding from the outer portion of the body 404, in which the car 403 includes a ribbed portion that is not present in the cars 402. However, in some embodiments (and as further described herein), each of the ears of the spray head adapter may include the ribbed portion. Further, the body 404 has a spatial opening 502 having the inner threaded portion 406 that engage with an outer threaded portion 210 of the outlet tube.

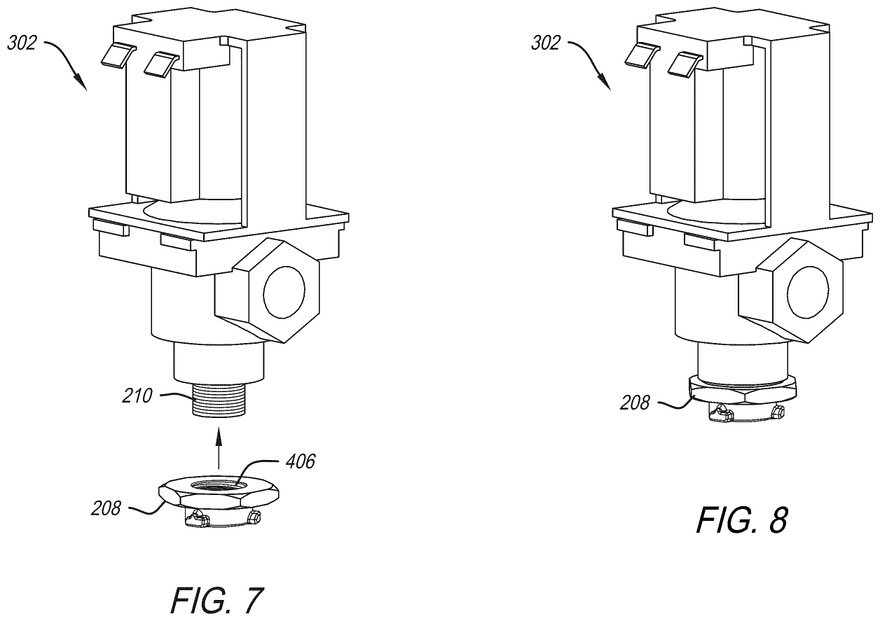

Referring now to FIG. 3, another exploded view of the spray head assembly 102 is shown relative to a valve 302 of the beverage brewer. The valve 302 includes the threaded portion 210 of the outlet tube. As shown in FIG. 3 and more particularly in FIGS. 7 and 8, the outer threaded portion 210 may engage with the inner threaded portion 406 to attach the valve 302 and adapter 208 with one another. Because the inner threaded portion 406 may be formed of a metallic material, engaging with the outer threaded portion 210 is less likely to result in cross-threading and subsequent damage to either threaded portion 210 or 406. Generally, in practice, the adapter 208 is not to be removed from the valve 302 during service. To this effect, in some embodiments, the adapter 208 may be further affixed to the valve 302 using an adhesive substance, such as a glue, for a more permanent fixture of the adapter 208 to the valve 302.

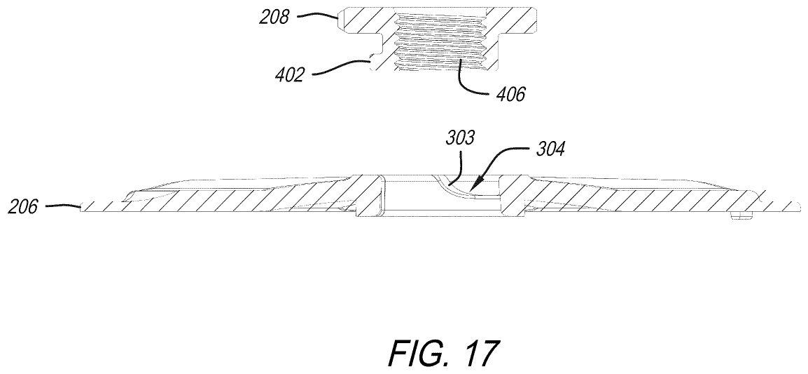

The adapter 208 is removably attachable to the backer plate 206. More particularly, the backer plate 206 includes a turn mechanism 303 (e.g., a “⅓ turn” mechanism) along the edges of a center opening 304 thereof used to engage with the ears 402 (and 403, if present) of the adapter 208. FIG. 17, which depicts a cross-section of the backer plate 206 and the adapter 208, further illustrates the turn mechanism 303. To attach, a user may fit the body 404 over the center opening 304 and turn the backer plate 206 until the ears 402 stop. The ears 402 engage the illustrated stop in the backer plate. In an embodiment, the turn mechanism 303 includes a sloped ridge and radii to guide a user in locating and fitting the optional ear 403 to the backer plate 206. Advantageously, this arrangement allows the user to more easily locate the ear 403 (if present) to the backer plate 206 in a “blind” assembly. In an embodiment, the backer plate 206 may include a rubber grip to allow the adapter 208 to be better seated relative to the backer plate 206 when engaged. The rubber grip may also allow a user to install the adapter 208 without needing any additional tools. As stated, generally in practice the adapter 208 is not to be removed once installed.

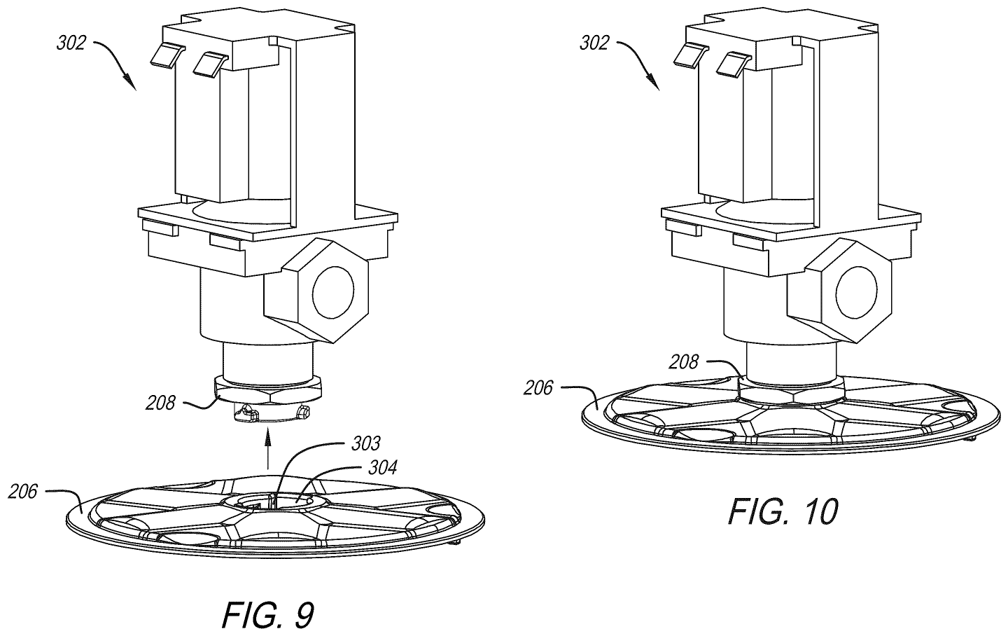

FIGS. 9 and 10 depict the attachment of the backer plate 206 to the adapter 208 that is connected with the valve 302. In this arrangement, a user that wishes to clean the spray head 102 does so by turning the backer plate 206 in a manner such that the backer plate 206 disengages with the adapter 208. Advantageously, this approach eliminates the potential of the threaded portion 210 of the valve 302 to misalign and damage the plastic spray head 102 by relocating the threading action to occur between the valve 302 and the adapter 208. In addition, as shown in FIG. 10 and other figures, the adapter 208 is of a greater radius than the unthreaded portion of the tube of the valve 302. Doing so provides a sealing between the spray head 102 and the valve 302 for pulse and to prevent air being drawn into the water flow of the spray head 102.

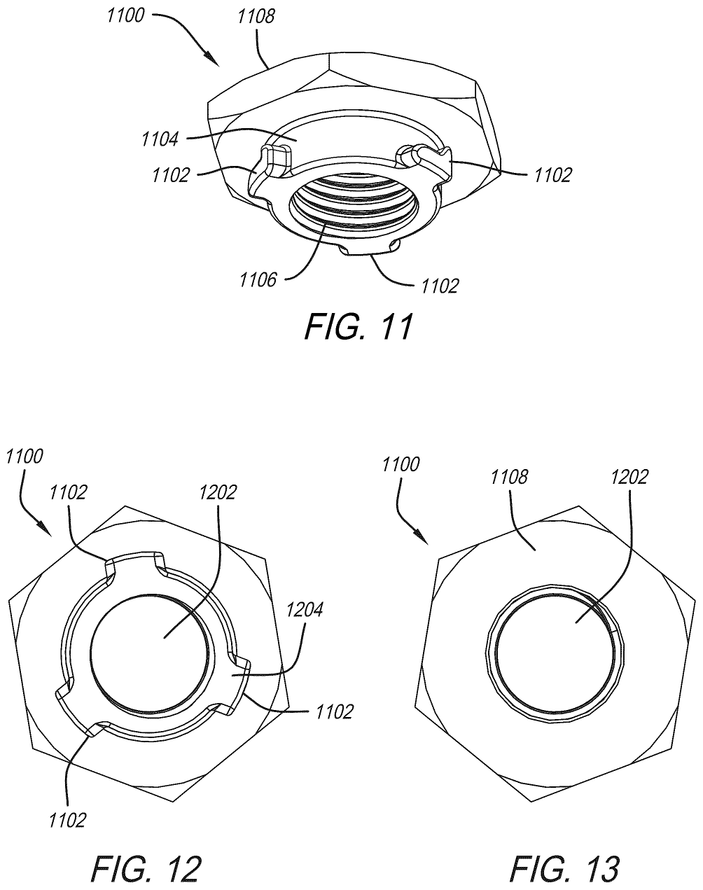

FIGS. 11-13 are various views of another embodiment of an adapter used to connect the valve 302 with the spray head assembly 102. More particularly, FIGS. 11-13 are views of an adapter 1100. FIG. 11 depicts a perspective view of the adapter 1100. FIG. 12 depicts a view of the bottom of the adapter 1100. FIG. 13 depicts an overhead view of the adapter 1100. As shown, the adapter 1100 includes a top portion 1108, a body 1104, and bottom portion 1204. The body 1104 is generally cylindrical in shape and includes cars 1102 protruding therefrom. Further, the body 1104 has a spatial opening 1202 having an inner threaded portion 1106 that can engage with the outer threaded portion 210 of the outlet tube.

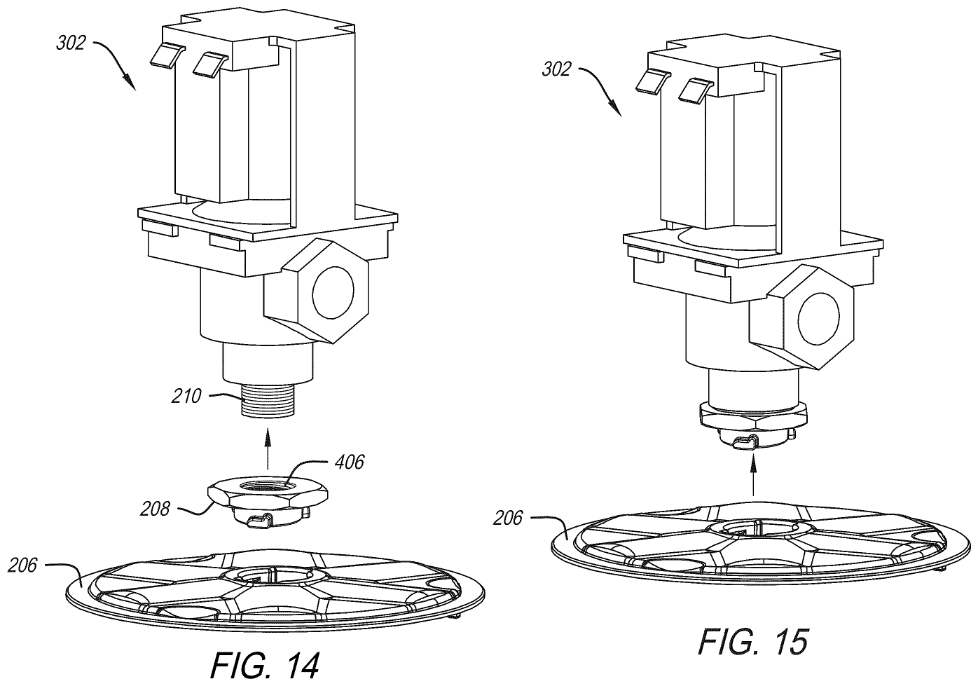

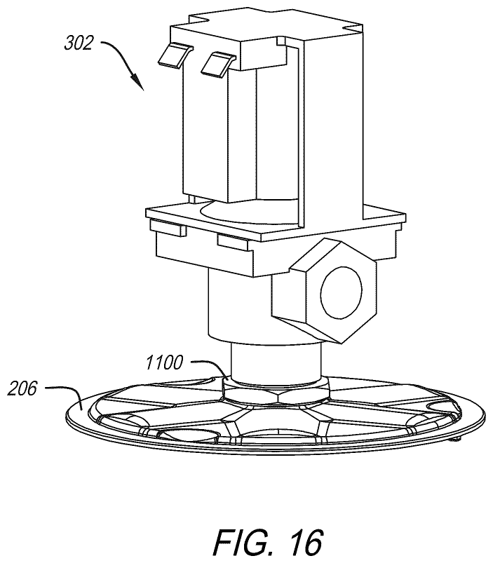

In contrast to the cars of spray head adapter 208, all of the cars 1102 on the body 1104 can include a ribbed portion for interlocking with the backer plate 206. Including ribbed portions on each car 1102 on the body 1104 may further secure the adapter 1100 to the backer plate 206 when engaged. Of course, additional embodiments may omit the ribbed features of the car 1102 and engage with the backer plate 206 using other means. FIGS. 14-16 are conceptual diagrams of a fitting of the valve 302 to the spray head assembly 102 via the spray head adapter 1100. The threaded portion 210 of the valve 302 may engage with the threaded portion 1106 to secure the adapter with the valve 302, as shown in FIGS. 14 and 15. To attach the spray head 102 to the brewer, the user may fit the body 1104 through the center opening 304 and turn the backer plate until the ribbed cars 1102 lock into place. FIGS. 15 and 16 depict the attachment of the backer plate 206 to the adapter 1100. In this arrangement, a user that wishes to clean the spray head 102 does so by turning the backer plate 206 in a manner such that the backer plate 206 disengages with the adapter 1100.

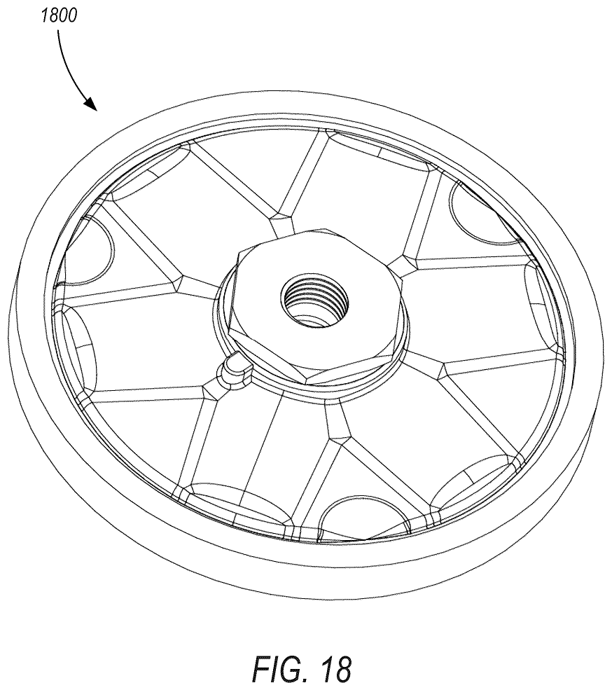

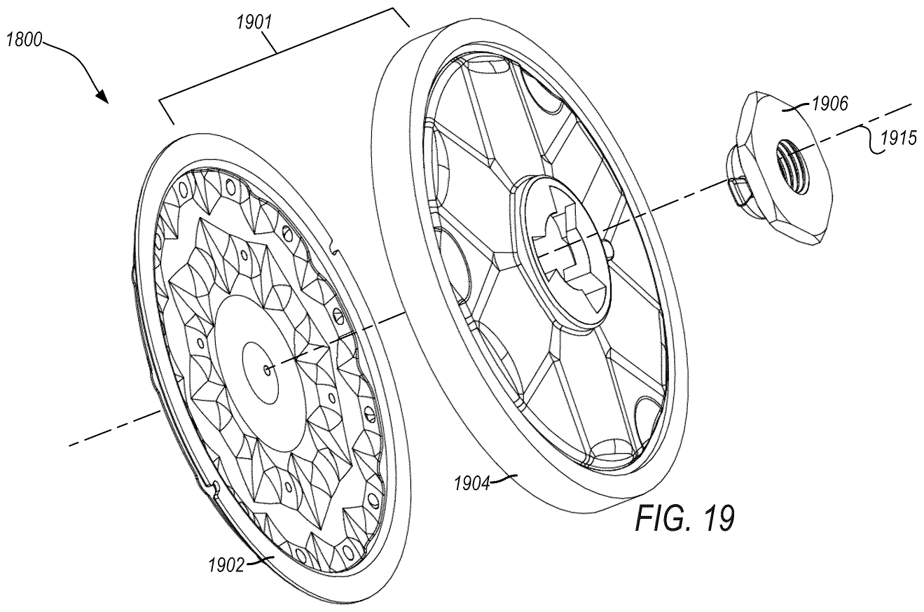

FIGS. 18-24A-C are directed to another embodiment of a spray head assembly of the present disclosure in which a backer plate portion of the spray head is formed of a flexible material (e.g., molded silicone, liquid silicone rubber, natural rubber, etc.) to provide a secure and at least generally watertight sealed connection between the water outlet tube of the brewer and the spray head. FIGS. 18 and 19 illustrate, respectively, an assembled perspective view and an exploded perspective view of a spray head assembly 1800. Illustratively, the spray head assembly 1800 of this embodiment only uses three pieces including a spray head 1901, formed of a generally rigid front portion 1902 and a flexible backer plate 1904, and a spray head adapter 1906.

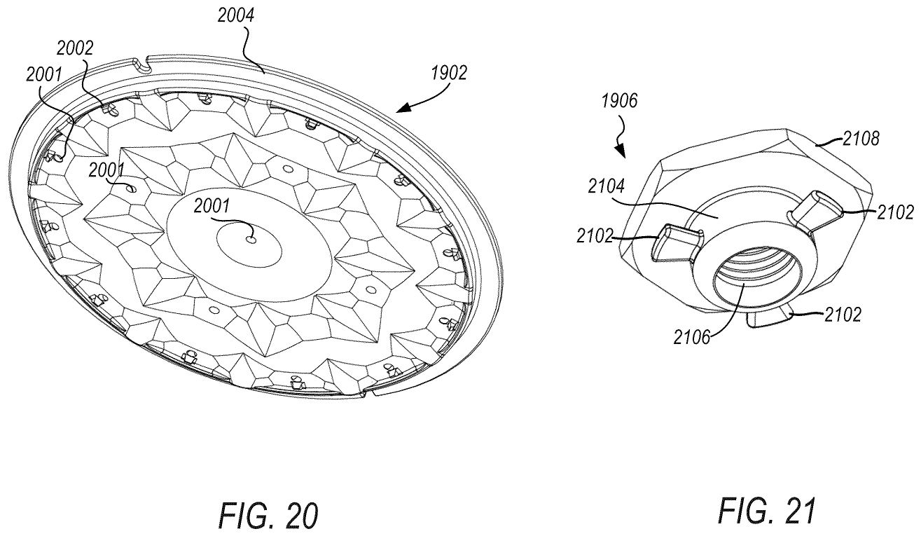

FIG. 20 depicts a view of the bottom of the front portion 1902. The front portion 1902 includes a number of passages or holes 2001 through which water is dispensed. The holes 2001 may be arranged in a configuration to direct the flow of water in a desired manner or pattern. The front portion 1902 also includes outward protrusions 2002 that further assist in directing the flow of water in a desired manner or pattern.

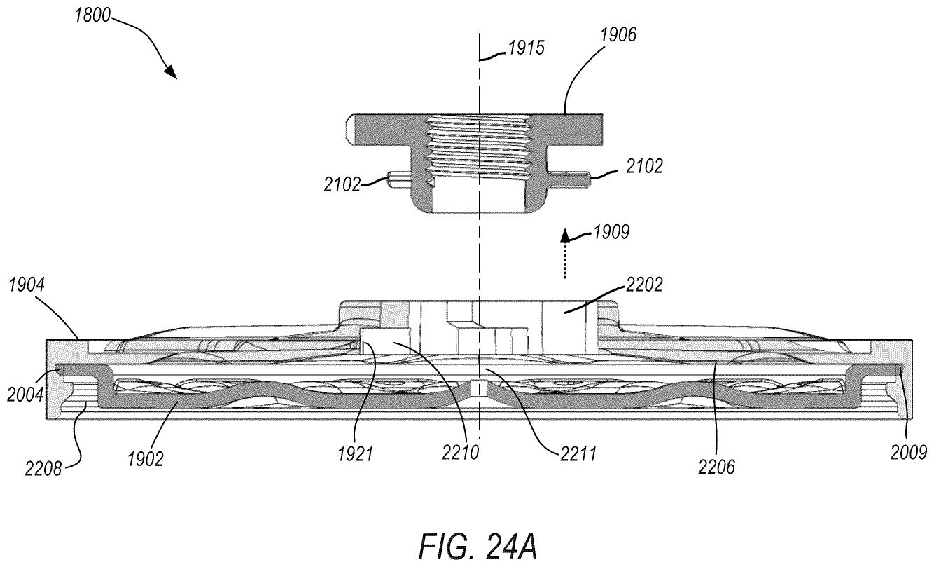

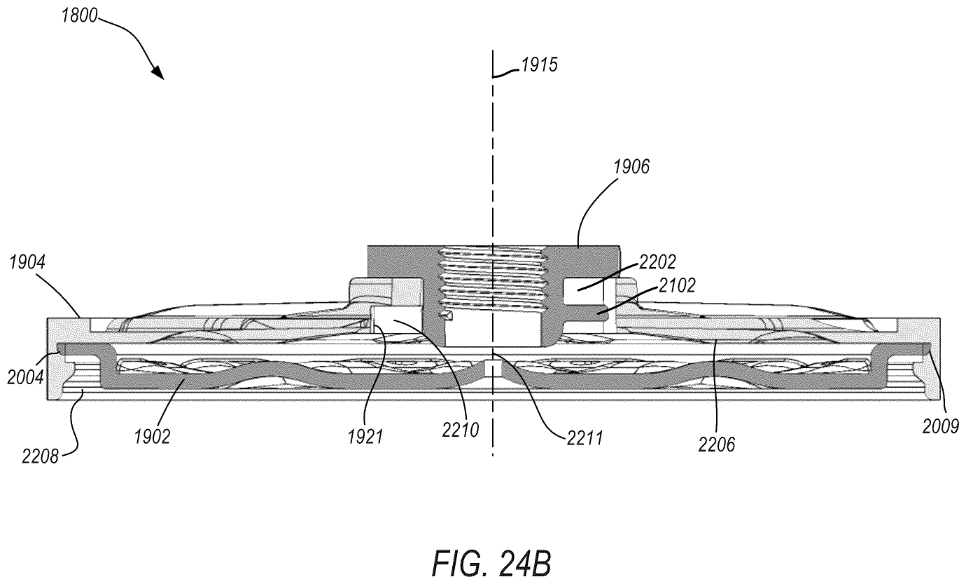

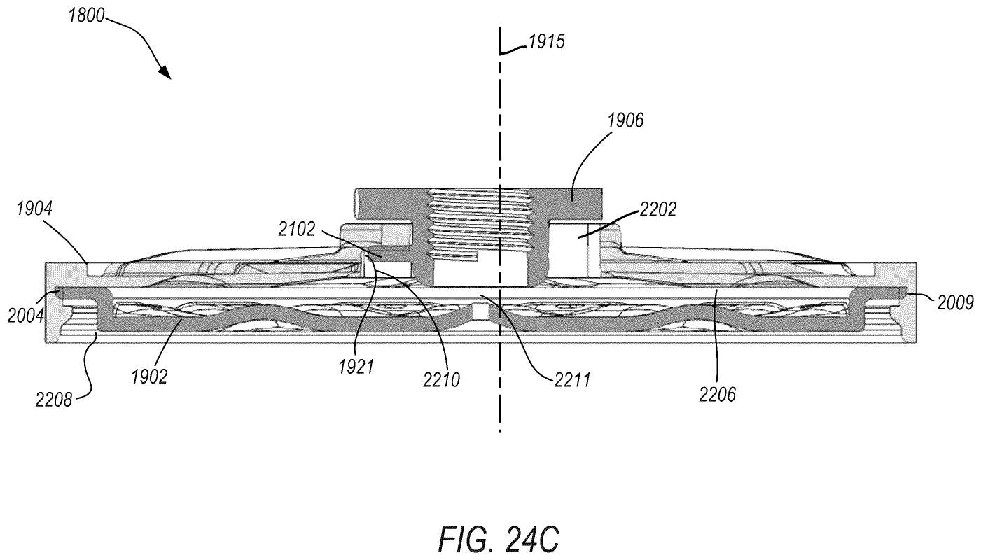

The front portion 1902 is engageable with the backer plate 1904 by fitting backer plate 1904 over the front portion 1902. The backer plate 1904 is preferably made of a flexible material (further described herein) that may be stretched over an outer rim 2004 of the front portion 1902 (which may be formed of a generally rigid material). In this configuration the rim 2004 fits over an inner annular ridge 2208 (shown in FIGS. 22B and 24A-24C) of the backer plate 1904. The inner annular ridge 2208 provides structural support for the backer and resists outward stretching when the spray head 1901 is at least slightly pressurized when filled with brew water during a brew cycle.

The rim 2004 is then positioned in the internal annular groove 2209. The engagement of the rim 2004 in the groove 2209 provides at least a generally watertight seal. Engagement of the front portion 1902 and backer plate 1904 define a cavity 2211 between the generally concave portions of the two pieces. Water dispensed from the brewer to the spray head 1901 fills the cavity 2211 and is dispensed through the holes 2001 in the front portion 1902.

In this embodiment, the front portion 1902 is described, as being generally rigid, and the backer 1904 is described as being flexible. The front portion 1902 may be formed of plastic, metal, or any other material that provides suitable generally rigid characteristics relative to the backer 1904. The reason for the relative flexibility and rigidity of these pieces is so that the backer 1904 can be attached to the front portion as described above. As such, the front portion 1902 could be formed of a material that has some degree of flexibility to it, while providing a generally rigid structure relative to the backer 1904. By providing this relationship, this embodiment can be configured in three pieces, front portion 1902, backer 1904, and adapter 1906. This is in contrast to the initial configuration described above, which includes four pieces, front portion 202, backer portion 206, gasket 204, and adapter 208. The reduction and the number of pieces in the spray head assembly 1800 helps to reduce costs, reduce part numbers, improve accountability, and tracking, and related improvements.

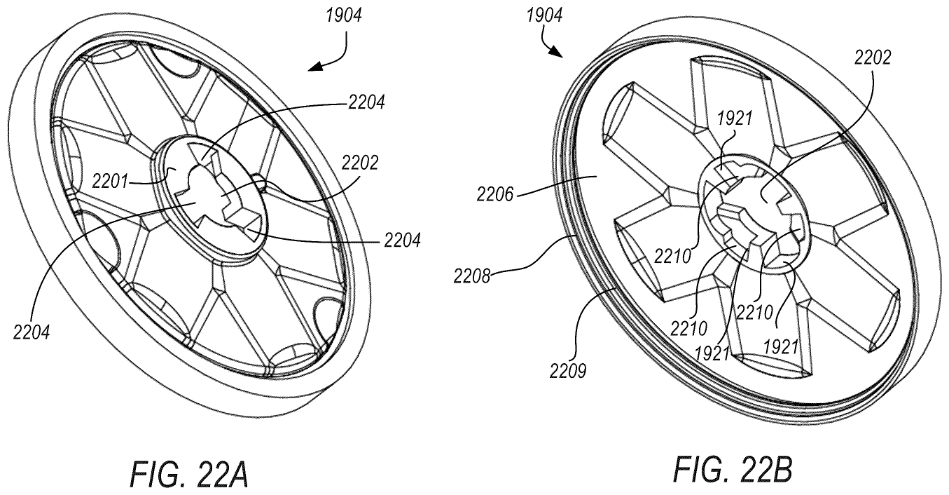

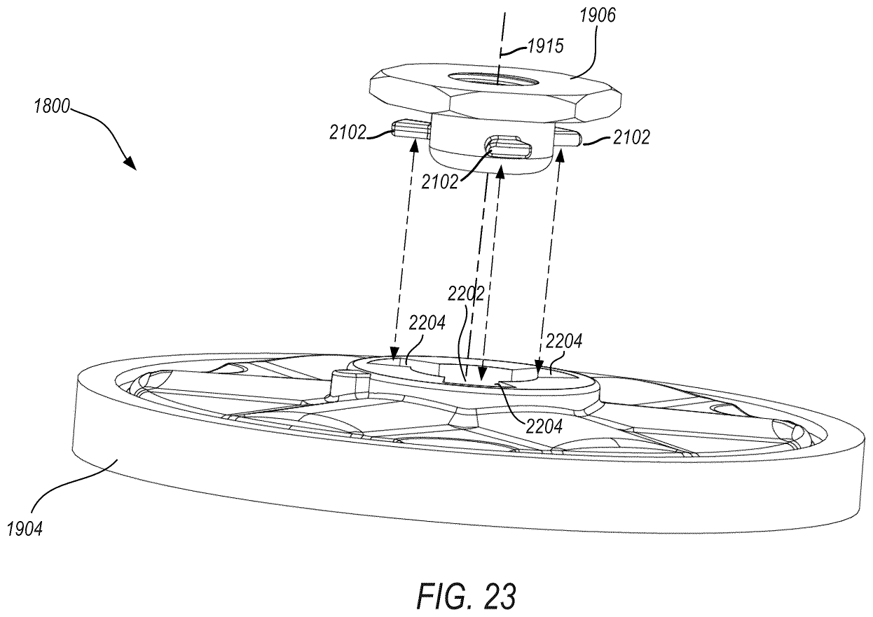

FIG. 21 depicts a perspective view of a bottom portion of the adapter 1906. The adapter 1906 includes tabs 2102, body 2104, inner threaded portion 2106, and top portion 2108. The body 2104 is generally cylindrical in shape having an outer portion and the inner threaded portion 2106. The tabs 2102 protrude outwardly from the body 2104 and are positioned on the body 2104 such that the tabs 2102 may be inserted into slots 2204 of the backer plate 1904 (as further shown related to FIGS. 23 and 24A-C). The threaded portion 2106 may extend to an opening on the top surface portion of the adapter 1906 and engage with an outer threaded portion (e.g., the threaded portion 210 of the outlet tube or valve). The adapter 1906 is a nut-shaped rigid member that may be formed of a material such as stainless steel (e.g., 300 series stainless steel), brass, nickel, aluminum, a plastics material having suitable characteristics to serve the functions of the adapter, and other suitable materials. Similar to the adapter 208, the top surface portion of the adapter 1906 may be generally hexagonal in shape, though other shapes may be used.

FIGS. 22A and 22B depict perspective views of a top portion (FIG. 22A) and a bottom portion or underside (FIG. 22B) of the backer plate 1904. Illustratively, the backer plate 1904 includes a spatial opening 2202 generally in the center thereof. The opening 2202 is generally circular in shape with a number of slots 2204 protruding outward from the circular opening. The slots 2204 are configured in a complementary configuration relative to the tabs 2102 so that the tabs 2102 may be inserted into the slots 2204 generally along a central axis 1915 (sec, FIGS. 19 and 23-24C) of the spray head 1901. Further, the backer plate 1904 includes one or more engagement portions 2210 communicating with and circumferentially off set from corresponding slots 2204. The engagement portions are sized and dimensioned to receive the tabs 2102 when the spray head is rotated about the axis 1915 to provide a securing mechanism for retaining the spray head 1901 on the adapter 1906.

The backer plate 1904 may be formed of a flexible material that is wear resistant, food contact-safe, and has sufficient heat resistance to withstand repeated heating from brew water (e.g., able to withstand temperatures of approximately 205 degrees Fahrenheit). Further, the material is preferably within a durometer measurement range between 50-70 durometer. Examples of such materials include flexible molded silicone, liquid silicone rubber, natural rubber, and the like.

As shown briefly in the conceptual diagram of FIG. 23, the slots 2204 are shaped to receive the tabs 2102 of the adapter 1906. A cross-sectional view of fitting the backer plate 1904 over the adapter 1906 is shown in FIG. 24A as shown by the arrow 1909. In the next progressive view of attaching the spray had 1901 on to the adapter 1906, FIG. 24B shows a cross-sectional view of the adapter 1906 and the backer plate 1904 in an initial position after insertion of the adapter 1904 into the hub of the backer plate through the spatial opening 2202. Once inserted, the backer plate 1904 may be rotated such that each tab 2102 circumferentially shifts into the respective engagement portions 2210 of the hub. In the final progression of FIG. 24C a cross-sectional view of the backer plate 1904 fully engaged with the adapter 1906 is shown.

In an embodiment, the engagement portions 2210 and tabs 2102 may be sized and dimensioned to provide a degree of interference fit such as by relative compression between the portions 2210 and 2102 resulting from the relative dimensions causing some suitable degree of compression of the relatively flexible material of the backer. The interference fit may also be provided by the facing surfaces of the portions 2210 and 2102 creating relative resistance or drag during engagement for a secure fit. Such interference fit may also provide an indication to the user when the adapter is engaging. A terminal point of rotation is reached to stop further rotation. This will occur when the tabs are stopped from further circumferential movement by reaching an end 1921 of the engagement portions 2210. This terminal point of rotation will provide feedback to the user that that no further rotation is needed and the spray head 1901 is secured on the adapter 1906.

In an embodiment, the engagement provides a complete seal given an interference fit of 0.03″ from left to right on the sides of the engagement portions 2210. The backer plate 1904 may be released from the adapter 1906 by rotating the backer plate in the opposite direction of engagement such that the tabs 2102 are dislodged from the engagement portions 2210 and removed through the slots 2204.

Advantageously, contact with the flexible material of the backer plate 1904 with the rigid material of the adapter 1906 enables a user to better gauge the seal and lock of the adapter 1906 with the backer plate 1904 based on the user feel of the resistance and drag as the components are engaged (or released) with one another. When fully engaged, the adapter 1906 provides a secure and watertight seal over the spatial opening 2202. To enable relative ease of engagement (and release) of the adapter 1906 to (and from) the backer plate 1904, the fit of the components should provide sufficient drag between the respective surfaces during engagement or release, though not too high of a drag that removal of the adapter 1906 is difficult.

In an embodiment, the spray head assembly 1800 is adaptable to retrofit with a variety of brewers. Prior approaches to creating such a spray head assembly have encountered challenges due to certain models of beverage brewing machines having a water delivery line of varying diameters and/or different thread sizes and configurations. To address such issues, the adapter 1906 may be produced in several configurations having different sizes and combinations of interior thread sizes and configurations, e.g., based on the threading and diameter of the water delivery line of the underlying brewer. Regardless of the size and thread configuration, the tabs 2102 protruding from the body 2104 will be configured with the same dimensions to remain adaptable to fit through the slots 2204 of the backer plate 1904. In this manner a single spray head 1901 may be use on a variety of adapters 1906 with all of the adapters 1906 having identical tab configurations to cooperatively engage the single spray head 1901 configuration, even though the thread and/or diameter of each adapter might be different to accommodate a corresponding brewer.

1. A spray head assembly for use with a beverage making apparatus comprising:
a spray head including a backer plate formed of a flexible material and a front portion formed of a rigid material;
an adapter formed of a rigid material having a body having an outer portion and a threaded inner portion, the body defining an opening through the threaded inner portion attachable to a water outlet tube of the beverage making apparatus, and the outer portion of the body including one or more tabs engageable with the backer plate of the spray head.

2. The spray head assembly of claim 1, further comprising one or more engagement portions carried in the backer plate, wherein the one or more of tabs engageable with the one or more engagement portions of the backer plate.

3. The spray head assembly of claim 2, further comprising the spray head is rotatable relative to the adapter to engage the tabs on the adapter with the with the one or more engagement portions on the backer portion.

4. The spray head assembly of claim 1, further comprises the front portion formed of a plastic material.

5. The spray head assembly of claim 4, further comprising the adapter is formed of a metal material.

6. The spray head assembly of claim 1, wherein the backer plate is formed of a silicone material.

7. The spray head assembly of claim 1, wherein the one or more tabs is lockable on the center opening of the backer plate through the one or more engagement portions of the backer plate.

8. The spray head assembly of claim 1, further comprising adhesive substance adhering the adapter to the valve.

9. An adapter for connecting a spray head to a valve, the adapter comprising:
a body having an outer portion and a threaded inner portion, the body further having an opening through the threaded inner portion attachable to the valve, and the outer portion of the body including one or more tabs engageable with the spray head.

10. The adapter of claim 9, wherein the spray head is attachable to the plurality of ears via a backer plate of the spray head.

11. The adapter of claim 10, wherein at least one of the plurality of ears includes a rib and wherein the one or more tabs are attachable to a center opening of the backer plate receivable for the one or more tabs.

12. The adapter of claim 11, wherein the one or more tabs is lockable on the center opening of the backer plate through one or more engagement portions of the backer plate.

13. The adapter of claim 9, wherein the adapter further comprises an adhesive substance to adhere the adapter to the valve.

14. The adapter of claim 9, wherein the adapter is formed of a metal material.
